(19) United States
(12) Patent Application Publication
(10) Pub. No.: US 2007/0147839 A1
(43) Pub. Date: Jun. 28, 2007

(54) Clock strobed data over one waveguide or fiber

(75) Inventor: David S. Dunning, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Intel Corporation

(21) Appl. No.: 11/317,751

(22) Filed: Dec. 23, 2005

(51) Int. Cl. H04J 14/02

(52) U.S. Cl. 398/79

(57) ABSTRACT

In some embodiments, clock strobed data over one waveguide or fiber is presented. In this regard, a transfer agent is introduced to convert one or more lanes of data and a corresponding clock strobe from electrical signals to optical signals of differing wavelengths. Other embodiments are also disclosed and claimed.

### FIELD OF THE INVENTION

Embodiments of the present invention generally relate to the field of communications, and, more particularly to clock strobed data over one waveguide or fiber.

### BACKGROUND OF THE INVENTION

Computing devices must transfer data between components including, for example, processors, memory controllers and devices, and input/output (I/O) controllers and devices. Typically a bus, or series of data lanes, is used to transfer data between components, or chips, either on the same circuit board or on separate boards. Routing of data signals can take up limited space on a circuit board. Furthermore, power may be wasted when a bus is underutilized.

### BRIEF DESCRIPTION OF THE DRAWINGS

The present invention is illustrated by way of example and not limitation in the figures of the accompanying drawings in which like references indicate similar elements, and in which:

FIG. 1 is a block diagram of an example electronic appliance suitable for implementing a transfer agent, in accordance with one example embodiment of the invention; and

FIG. 2 is a block diagram of an example communication link, in accordance with one example embodiment of the invention.

### DETAILED DESCRIPTION

In the following description, for purposes of explanation, numerous specific details are set forth in order to provide a thorough understanding of the invention. It will be apparent, however, to one skilled in the art that embodiments of the invention can be practiced without these specific details. In other instances, structures and devices are shown in block diagram form in order to avoid obscuring the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments.

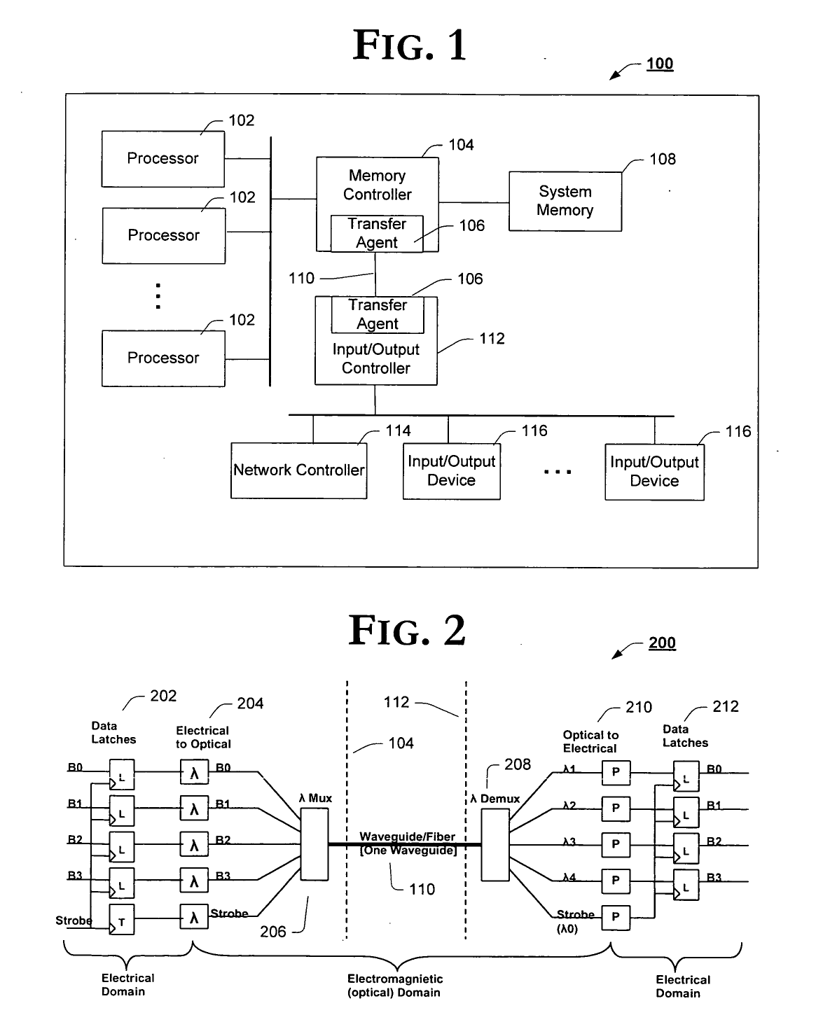

FIG. 1 is a block diagram of an example electronic appliance suitable for implementing a transfer agent, in accordance with one example embodiment of the invention. Electronic appliance 100 is intended to represent any of a wide variety of traditional and non-traditional electronic appliances, laptops, desktops, cell phones, wireless communication subscriber units, wireless communication telephony infrastructure elements, personal digital assistants, set-top boxes, or any electric appliance that would benefit from the teachings of the present invention. In accordance with the illustrated example embodiment, electronic appliance 100 may include one or more of processor(s) 102, memory controller 104, transfer agents 106, system memory 108, waveguide 110, input/output (I/O) controller 112, network controller 114, and input/output device(s) 116 coupled as shown in FIG. 1. Transfer agent 106, as described more fully hereinafter, may well be used in electronic appliances of greater or lesser complexity than that depicted in FIG. 1. Also, while shown as connecting memory controller 104 and I/O controller 112, transfer agent 106 could be incorporated into other components as alternate embodiments of the present invention. For example, in one embodiment processor(s) 102 may include transfer agents 106 with multiple point-to-point connections coupling processor(s) 102 with memory controller 104.

Processor(s) 102 may represent any of a wide variety of control logic including, but not limited to one or more of a microprocessor, a programmable logic device (PLD), programmable logic array (PLA), application specific integrated circuit (ASIC), a microcontroller, and the like, although the present invention is not limited in this respect.

Memory controller 104 may represent any type of chipset or control logic that interfaces system memory 108 with the other components of electronic appliance 100. In one embodiment, the connection between processor(s) 102 and memory controller 104 may be referred to as a front-side bus. In another embodiment, memory controller 104 may be referred to as a north bridge.

Transfer agent 106 may have an architecture as described in greater detail with reference to FIG. 2. Transfer agent 106 may have the ability to convert one or more lanes of data and a corresponding clock strobe from electrical signals to optical signals of differing wavelengths. Transfer agent 106 may also have the ability to convert received optical signals of differing wavelengths into separate electrical signals. In one embodiment, transfer agent 106 may be composed of separate transmitting and receiving circuitry. In another embodiment, transfer agent 106 may utilize at least some of the same circuitry to transmit and to receive the optical signals.

System memory 108 may represent any type of memory device(s) used to store data and instructions that may have been or will be used by processor(s) 102. Typically, though the invention is not limited in this respect, system memory 108 will consist of dynamic random access memory (DRAM). In one embodiment, system memory 108 may consist of Rambus DRAM (RDRAM). In another embodiment, system memory 108 may consist of double data rate synchronous DRAM (DDRSDRAM).

Waveguide 110 may represent a fiber-optic cable or other medium conducive to the low loss transmission of optical signals. In one embodiment, waveguide 110 is a bidirectional communication link between transfer agents 106. In another embodiment, separate unidirectional waveguides are utilized. Waveguide 110 may be chosen based on the wavelengths of the signals to be carried. In this way, the time of flight of signals of differing wavelengths may be matched so as to eliminate the need to compensate for the skew between signals and clocks or strobes.

Input/output (I/O) controller 112 may represent any type of chipset or control logic that interfaces I/O device(s) 116 with the other components of electronic appliance 100. In one embodiment, I/O controller 112 may be referred to as a south bridge. In another embodiment, I/O controller 108 may comply with the Peripheral Component Interconnect (PCI) Express™ Base Specification, Revision 1.0a, PCI Special Interest Group, released Apr. 15, 2003.

Network controller 114 may represent any type of device that allows electronic appliance 100 to communicate with other electronic appliances or devices. In one embodiment, network controller 110 may comply with a The Institute of Electrical and Electronics Engineers, Inc. (IEEE) 802.11b standard (approved Sep. 16, 1999, supplement to ANSIEEE Std 802.11, 1999 Edition). In another embodiment, network controller 110 may be an Ethernet network interface card.

Input/output (I/O) device(s) 116 may represent any type of device, peripheral or component that provides input to or processes output from electronic appliance 100.

FIG. 2 is a block diagram of an example communication link, in accordance with one example embodiment of the invention. As shown, communication link 200 may include one or more of transmitter data latches 202, optical converters 204, wavelength multiplexer 206, waveguide 110, wavelength demultiplexer 208, electrical converters 210 and receiver data latches 212 coupled as shown in FIG. 2. It is to be appreciated that although depicted as communication from memory controller 104 to I/O controller 112, communication may well occur in either or both directions. Also, communications can occur between different chips on the same circuit board or between components of separate circuit boards or devices. Communication link 200 may have the ability to power down circuitry in the event that there is no communication to be sent, thereby saving power. Communication link 200 may be designed such that the lengths of traces provide for a uniform time of flight of signals, thereby eliminating the need for complex clock data recovery (CDR) circuitry.

Data latches 202 represent storage devices that store the electrical signals that are to be communicated. Although depicted as four data lanes (B0-B3) and one clock strobe, the present invention is not so limited and may include any number of data lanes and clock signals. In one embodiment, the data stored in data latches 202 may be contents of system memory 108 that are to be sent to network controller 114.

Optical converters 204 represent circuitry to convert the data stored in data latches 202 to optical signals. In one embodiment, the data lanes (B0-B3) and the clock strobe have separate circuitry to convert each electrical signal to optical signals of differing wavelengths.

Wavelength multiplexer 206 represents a multiplexer capable of combining optical signals of varying wavelength onto waveguide 110. In one embodiment, wavelength multiplexer 206 combines the optical signals from optical converters 204 onto waveguide 110 without significant signal loss or distortion.

Wavelength demultiplexer 208 represents a demultiplexer capable of separating optical signals of varying wavelength received from waveguide 110. In one embodiment, the optical signal input is split into multiple outputs and provided to electrical converters 210.

Electrical converters 210 represent circuitry to convert optical signals to electrical signals. In one embodiment, electrical converters 210 receive the optical signals and convert each wavelength to an electrical signal provided to receiver data latches 212.

Receiver data latches 212 represent storage devices that store the electrical signals that are converted by electrical converters 210. In one embodiment, receiver data latches 212 store the data so that it may be transmitted along a different bus, for example a PCI Express bus. In one embodiment, the clock signal for receiver data latches 212 is a received signal provided by electrical converters 210.

Many of the methods are described in their most basic form but operations can be added to or deleted from any of the methods and information can be added or subtracted from any of the described messages without departing from the basic scope of the present invention. Any number of variations of the inventive concept is anticipated within the scope and spirit of the present invention. In this regard, the particular illustrated example embodiments are not provided to limit the invention but merely to illustrate it. Thus, the scope of the present invention is not to be determined by the specific examples provided above but only by the plain language of the following claims.

What is claimed is:

1. A method comprising:
converting one or more lanes of data and a corresponding clock strobe from electrical signals to optical signals of differing wavelengths.

2. The method of claim 1, further comprising multiplexing the optical signals over a waveguide.

3. The method of claim 1, wherein the waveguide is a fiber-optic cable.

4. The method of claim 1, further comprising demultiplexing the lanes and the clock strobe.

5. The method of claim 4, further comprising converting the optical signals back to electrical signals.

6. The method of claim 4, further comprising transmitting the electrical signals over a data bus.

7. An electronic appliance, comprising:
a processor to process data;
a network controller to communicate data; and
a transmitting agent, wherein the transmitting agent converts one or more lanes of data and a corresponding clock strobe from electrical signals to optical signals of differing wavelengths.

8. The electronic appliance of claim 7, further comprising the transmitting agent to multiplex the optical signals over a waveguide.

9. The electronic appliance of claim 7, further comprising a receiving agent to demultiplex the optical signals.

10. The electronic appliance of claim 9, further comprising the receiving agent to convert the optical signals back to electrical signals.

11. An apparatus comprising:
an electrical interface;
an optical interface; and
circuitry coupled to the electrical and optical interfaces to convert one or more lanes of data and a corresponding clock strobe from electrical signals to optical signals of differing wavelengths.

12. The apparatus of claim 11, further comprising:
circuitry to multiplex the optical signals over a waveguide.

13. The apparatus of claim 12, wherein the waveguide is a fiber-optic cable.

14. The apparatus of claim 12, further comprising circuitry to store the electrical signals.

15. The apparatus of claim 12, further comprising circuitry to transmit the optical signals to a silicon component on a same board.

16. An apparatus, comprising:
an electrical interface;
an optical interface; and
circuitry coupled to the electrical and optical interfaces to convert one or more lanes of data and a corresponding clock strobe from optical signals of differing wavelengths to electrical signals.

17. The apparatus of claim 16, further comprising circuitry to demultiplex the optical signals off a waveguide.

18. The apparatus of claim 17, further comprising circuitry to store the electrical signals.

19. The apparatus of claim 17, further comprising circuitry to transmit the electrical signals over a data bus.

20. The apparatus of claim 16, further comprising circuitry to receive the optical signals from a silicon component on a different board.
